(19) United States
(12) Patent Application Publication
(10) Pub. No.: US 2013/0318000 A1
(43) Pub. Date: Nov. 28, 2013

(54) Auto Ship Program that Adjusts to Consumer's Usage

(71) Applicants: Bryce Adam Engstrom, Broomfield, CO (US); Jeffrey Michael Harmon, Provo, UT (US); Robert John Stevens, Highland, UT (US); Neal Stoker Harmon, Provo, UT (US)

(72) Inventors: Bryce Adam Engstrom, Broomfield, CO (US); Jeffrey Michael Harmon, Provo, UT (US); Robert John Stevens, Highland, UT (US); Neal Stoker Harmon, Provo, UT (US)

(21) Appl. No.: 13/901,334

(22) Filed: May 23, 2013

Related U.S. Application Data
(60) Provisional application No. 61/651,346, filed on May 24, 2012.

(51) Int. Cl. G06Q 10/08

(52) U.S. Cl. CPC G06Q 10/083
USPC 705/337

(57) ABSTRACT

The present invention extends to methods, systems, and computer program products for implementing an auto ship program that adjusts the quantity of goods shipped based on the consumer's usage of the goods. In some embodiments, the auto ship program of the present invention receives consumer notifications indicating that a unit of a shipment has been opened or finished. The program employs the notifications to determine a rate at which the consumer is using units of the goods. If the rate at which the consumer is using the units differs from the rate at which the units are being shipped, the program can suggest or automatically make adjustments to the shipment rate. These adjustments can include modifying the number of units that are shipped in one or more future shipments or changing when one or more future shipments will be sent.

### CROSS-REFERENCE TO RELATED APPLICATIONS

This application claims the benefit of U.S. Provisional Patent Application No.: 61/651,346 which was filed on May 24, 2012.

### BACKGROUND

Many consumer goods are sold using an auto ship program. Auto ship programs offer recurring shipments of consumer goods directly to the consumer's home. In such programs, a quantity of goods is shipped on a periodic (e.g. monthly) basis. This quantity may be specified by the consumer upon joining the auto ship program, and may or may not be adjustable by the consumer.

One problem that exists with auto ship programs is that the consumer may accumulate an excess of goods if he does not use the received goods at the rate at which they are shipped. Similar issues arise when the consumer does not receive a sufficient quantity of goods from the automatic shipments. In such scenarios, the consumer often cancels his enrollment in the auto ship program. Even if the auto ship program allows the consumer to adjust the rate of shipments or quantity of items in the shipments, it is difficult for the consumer to gauge his needs accurately.

### BRIEF SUMMARY

The present invention extends to methods, systems, and computer program products for implementing an auto ship program that adjusts the quantity of goods shipped based on the consumer's usage of the goods. The auto ship program of the present invention receives consumer notifications indicating that certain events have occurred. These notifications are used to establish a pattern of usage. They may notify that a shipment of consumer goods has been received, a seal on a consumer good has been broken, a good has been opened, a good is low, near depletion, or at the end of its usefulness, or the good is empty or has been used. These notifications can be used to calculate the number of units that should be shipped in the next automatic shipment, or when the next automatic shipment should be shipped.

In one embodiment of an auto ship program, a consumer scans a consumer good (e.g. a scannable code on the consumer good) which causes a notification to be sent to the company providing the consumer goods indicating that the consumer needs additional consumer goods. In this case, there is no subscription program, only an auto ship on demand.

In another embodiment of an auto ship program in which a subscription for recurring shipments is used, a notification is received from a consumer when the shipment of consumer goods has been received. The consumer later scans each individual consumer good when it has been used or is near depletion. The number of units of the consumer good that will be sent to the consumer in the next shipment of the auto ship program is then automatically adjusted.

If, based on the notifications, it is determined that the consumer is using the consumer goods at a faster rate than they are being shipped, the auto ship program may respond with a message asking if the consumer would like to receive more consumer goods per shipment for an increased subscription fee. Similarly, if, based on the notifications, it is determined that the consumer is using the consumer goods at a slower rate than they are being shipped, the auto ship program may respond with a message asking if the consumer would like to receive fewer consumer goods per shipment for a reduced subscription fee. In both instances the consumer can respond affirmatively and upgrade or downgrade his subscription. In other instances, the upgrade or downgrade may be made automatically such as when the consumer has selected automatic adjustments.

In one embodiment, the present invention is implemented as a method for adjusting the quantity of consumer goods shipped as part of an auto ship program. A notification is received from a consumer, the notification indicating that the consumer has opened or finished a unit of a consumer good that was shipped to the consumer in a shipment of an auto ship program. It is determined how long it took the consumer to finish the unit based on when the notification was received. The number of units of the consumer good that will be sent to the consumer in the next shipment of the auto ship program is then adjusted.

In another embodiment, the present invention is implemented as a method for adjusting the quantity of consumer goods shipped as part of an auto ship program. A first notification is received from a consumer, the first notification indicating that the consumer has opened a unit of a consumer good that was shipped to the consumer in a shipment of an auto ship program. A second notification is also received from the consumer, the second notification indicating that the consumer has finished the unit of a consumer good. The second notification also indicates how many units of the consumer good the consumer still has that are unused. It is determined, using the time when the first and second notifications were received, how long it took the consumer to finish the unit. It is also determined whether the consumer's rate of use of the consumer good differs from the rate at which the consumer good is being shipped. Upon determining that the consumer's rate of use differs, a prompt is sent to be displayed to the consumer to request that the consumer adjust the number of units of the consumer good that are shipped in each shipment of the auto ship program; A request is then received from the consumer to adjust the number of units that are shipped to match the rate at which the consumer is using the consumer good. The number of units that are to be shipped in future shipments is then automatically adjusted.

In another embodiment, the present invention is implemented as a method for automatically determining the rate at which a consumer is using consumer goods that are shipped as part of an auto ship program. A first notification is received from a consumer, the first notification indicating that the consumer has finished a unit of a consumer good that was shipped to the consumer in a shipment of an auto ship program. Account information of the consumer's auto ship program is accessed to identify a rate at which the consumer is using units of the consumer good. An indication of the rate is then sent to a computer device of the consumer.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary networked environment in which the present invention can be implemented;

FIG. 2 illustrates a tube of toothpaste that includes a scannable code;

FIG. 3 illustrates dental floss that includes a scannable code;

FIGS. 4A-4C illustrate example user interfaces that can be displayed by a mobile application to assist a consumer in scanning a unit of a consumer good;

FIGS. 5A-5C illustrate example user interfaces that can be displayed to a consumer to assist the consumer in determining whether to approve an adjustment to the shipment rate of a consumer good;

FIG. 6 illustrates a flowchart of a method for adjusting the quantity of consumer goods shipped as part of an auto ship program;

FIG. 7 illustrates a flowchart of a method for adjusting the quantity of consumer goods shipped as part of an auto ship program; and

FIG. 8 illustrates a flowchart of a method for automatically determining the rate at which a consumer is using consumer goods that are shipped as part of an auto ship program.

### DETAILED DESCRIPTION

The present invention extends to methods, systems, and computer program products for implementing an auto ship program that adjusts the quantity of goods shipped based on the consumer's usage of the goods. The auto ship program of the present invention receives consumer notifications indicating that certain events have occurred. These notifications are used to establish a pattern of usage. They may notify that a shipment of consumer goods has been received, a seal on a consumer good has been broken, a good has been opened, a good is low, near depletion, or at the end of its usefulness, or the good is empty or has been used. These notifications can be used to calculate the number of units that should be shipped in the next automatic shipment, or when the next automatic shipment should be shipped.

In one embodiment of an auto ship program, a consumer scans a consumer good (e.g. a scannable code on the consumer good) which causes a notification to be sent to the company providing the consumer goods indicating that the consumer needs additional consumer goods. In this case, there is no subscription program, only an auto ship on demand.

In another embodiment of an auto ship program in which a subscription for recurring shipments is used, a notification is received from a consumer when the shipment of consumer goods has been received. The consumer later scans each individual consumer good when it has been used or is near depletion. The number of units of the consumer good that will be sent to the consumer in the next shipment of the auto ship program is then automatically adjusted.

If, based on the notifications, it is determined that the consumer is using the consumer goods at a faster rate than they are being shipped, the auto ship program may respond with a message asking if the consumer would like to receive more consumer goods per shipment for an increased subscription fee. Similarly, if, based on the notifications, it is determined that the consumer is using the consumer goods at a slower rate than they are being shipped, the auto ship program may respond with a message asking if the consumer would like to receive fewer consumer goods per shipment for a reduced subscription fee. In both instances the consumer can respond affirmatively and upgrade or downgrade his subscription. In other instances, the upgrade or downgrade may be made automatically such as when the consumer has selected automatic adjustments.

Example Computer Architecture

Embodiments of the present invention may comprise or utilize a special purpose or general-purpose computers including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system.

Computer-readable media is categorized into two disjoint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similarly storage medium which can be used to store desired program code means in the form of computer-executable instructions or data structures and which can be accessed by a general purpose or special purpose computer. Transmission media include signals and carrier waves.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Example Computer Environment

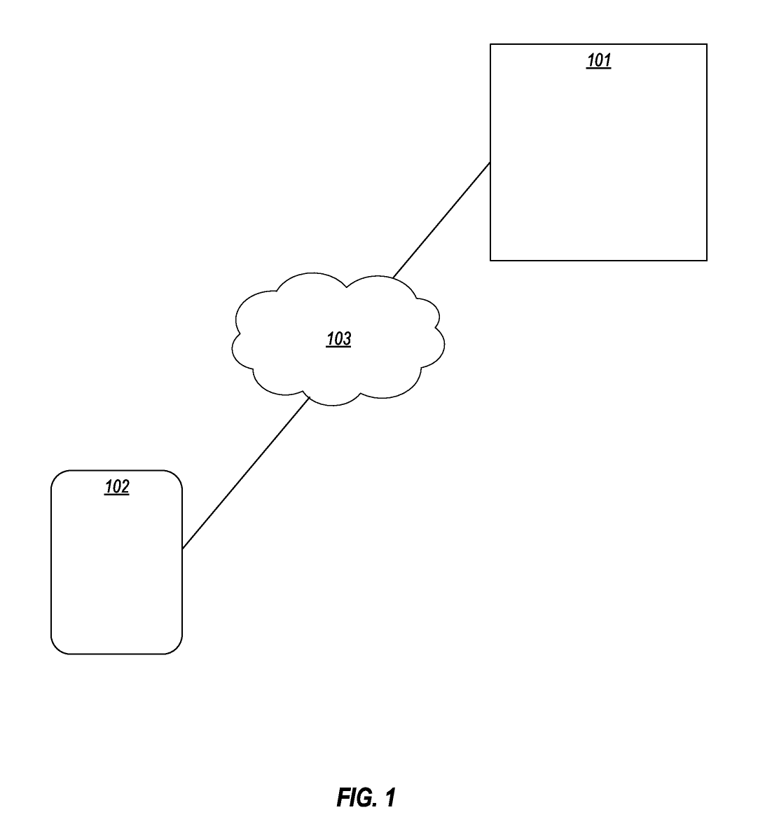

FIG. 1 illustrates an exemplary networked environment 100 in which the present invention can be implemented. Networked environment 100 includes computer system 101, computer system 102, and network 103. Network 103 can represent the internet and any of the various means of connecting to the internet. Accordingly, computer system 102 generally connects to computer system 101 via the internet although any other network could also be used.

Computer system 101 represents the computer system used by a provider of an auto ship program. Computer system 101 can therefore be one or more computer systems functioning as servers (including a cluster of servers (e.g. a cloud)), or any other computer system capable of communicating with computer system 102 to receive and process auto ship program related messages.

Computer system 102 represents the computer system used by a consumer enrolled in an auto ship program. Accordingly, computer system 102 can be a tablet, laptop, or desktop computer, a mobile phone, or any other computer system capable of communicating usage information to computer system 101 as further described below.

In a typical embodiment, computer system 101 provides a web site on which a consumer can subscribe to an auto ship program. For example, a consumer can create an account on the website, and order the desired goods to be supplied via the auto ship program. Accordingly, a consumer can interact with computer system 101 to enroll in an auto ship program using various types of computer systems as is known in the art.

An type of consumer good can be shipped as part of an auto ship program in accordance with embodiments of the invention. For example, hygiene goods such as toothpaste, toothbrushes, floss, mouthwash, teeth whitening products, shampoo, conditioner, soap, razors, etc. or any other type of good that a consumer purchases on a periodic basis can be shipped in the auto ship program.

Adjusting an Auto Ship Program Based on Notifications Regarding a Consumer's Usage Rate of Goods Shipped in the Auto Ship Program

In many auto ship programs, a consumer will specify an initial quantity of goods to be shipped in each shipment. In some cases, the consumer can also specify the interval between shipments. For example, if the consumer was ordering toothpaste, the user may initially specify that three tubes of toothpaste should be shipped in each automatic shipment. In response, computer system 101 will cause three tubes of toothpaste to be shipped to the consumer at some periodic interval (e.g. monthly or quarterly).

Following this process, the consumer begins receiving the ordered goods. As stated above, if the consumer does not use the ordered goods at the same rate at which they are being shipped, the consumer will run out of the goods before the next shipment is received, or accumulate an excess of goods. To address this issue, the present invention provides means to track the consumer's actual use of the received goods and automatically update the quantities that will be shipped in the next shipment.

To automatically update the quantity of goods to ship, computer system 101 is configured to allow the consumer to communicate notifications of the actual use of units of the received goods. Specifically, a shipment of an auto ship program generally contains multiple units of a particular consumer good. For example, if the consumer is enrolled in an auto ship program to receive toothpaste, a single shipment may contain two or more tubes of toothpaste.

When a consumer begins, is low on, or finishes using a unit of a multiple unit shipment, the consumer notifies computer system 101 that the unit has been started, is near the end of its life, or finished respectively. Computer system 101 uses this information to automatically adjust the number of units to ship in the next shipment. For example, because computer system 101 knows when the shipment was shipped to (or received by) the consumer, computer system 101 can determine how long it took the consumer to use one unit of the good. Similarly, subsequent notifications from the consumer can inform computer system 101 of how long it took the consumer to finish a second, third, fourth, etc. unit.

For example, if the consumer is initially enrolled in an auto ship program to receive three tubes of toothpaste every quarter, and a month and a half after sending the first shipment of three tubes of toothpaste, computer system 101 receives notification from the consumer that a first tube has been used, computer system 101 can determine from the shipment date of the first shipment and from the date that the notification is received that the consumer is using tubes of toothpaste at a rate of two per quarter.

Because the consumer's current auto ship program is configured to ship three tubes of toothpaste a quarter, and because computer system 101 can anticipate that the consumer will still have one unused tube of toothpaste at the time of the next shipment, computer system 101 can update the consumer's auto ship program so that two tubes are shipped in subsequent shipments (or one tube in the next shipment and two tubes thereafter). In this manner, the quantity of goods shipped with each shipment can be automatically adjusted as needed to ensure that the consumer never runs out or accumulates an excess of goods.

Another benefit of automatically determining the quantity to ship is that the consumer does not need to calculate how much is needed. Oftentimes, even if the consumer has the ability to adjust the quantity to be shipped in future shipments, the consumer is not aware of how long it took to finish a unit of a good, and is therefore unable to determine the appropriate quantity to request in the next shipment. For example, the same consumer receiving toothpaste may be unaware that it took a month and a half to use one tube, and therefore may not be able to accurately determine how much toothpaste he should request in the next shipment.

Using the techniques of the present invention, the consumer need not be concerned about how much of an item he is using because he only has to send the notification that a unit has been finished, and computer system 101 will determine the appropriate quantity to send in the next shipment automatically.

The notification that a unit of a good has been finished can be generated and sent in various manners. For example, computer system 101 could provide a web site on which the consumer could submit notifications. Computer system 101 could also be configured to receive notifications via messages such as text or email.

In some embodiments of the invention, the individual units of goods can include a scannable code (e.g. a bar or QR code). In such embodiments, when the consumer finishes the unit, he can scan the code on the unit using computer system 102 (e.g. a mobile phone or other computer device having scanning capability). Once scanned, computer system 102 can be configured to automatically generate and send a notification to computer system 101. In other such embodiments, when the consumer opens the unit, he can scan the code on the unit using computer system 102. The package for the unit can include instructions to scan before opening.

By sending notifications when a unit is started, a rate of use of the consumer good can be more accurately determined For example, if the shipment date, rather than the date when the consumer starts using the unit, is used to determine rate of use, the determined rate of use may be less accurate. This is because some consumers may store the goods before use, and therefore basing the start date on the shipment confirmation date will be inaccurate. In contrast, if the consumer generates a notification when the unit is started (e.g. before the seal on the unit is broken) and when the unit is finished, a more accurate rate of use can be determined

A scannable code used on a unit of a consumer good can contain sufficient information to identify the type of good on which it is placed. For example, a unique code can be used for all tubes of toothpaste of the same type. In such embodiments, once the code is scanned, computer system 102 (i.e. an application or service on computer system 102) can create a notification that includes information identifying the consumer and the information contained within the code, and send the notification to computer system 101.

In some embodiments, either computer system 101 or computer system 102 can maintain a count of the number of units of a consumer good that a consumer should have. When the consumer scans a code on a unit upon finishing the unit, computer system 102 can prompt the user to confirm how many units still remain unused. If the count displayed to the consumer is incorrect, the prompt can include user interface controls for modifying the stored count. Once the count is confirmed or adjusted, a notification of the unit being finished can be sent to computer system 101 for determining whether the number of units to be shipped in future shipments should be adjusted. Accordingly, by prompting the consumer to confirm the number of units remaining, any units that the consumer forgot to scan upon finishing can be accounted for.

Accordingly, computer system 101 will receive the consumer's notification from computer system 102 which can include an identifier for the consumer, an identifier for the product, and, in some embodiments, the number of units the consumer has remaining in stock (e.g. 0, ½, 1, 2 etc.).

From the information in the notification and from the consumer's shipment history (or from a previous notification(s) such as when the consumer scans upon opening a unit), computer system 101 calculates the consumer's usage rate. In some embodiments, if the consumer's usage rate differs from the rate at which the consumer goods are being shipped, the number of consumer goods to be shipped in future shipments can be automatically adjusted.

In some embodiments, however, the consumer may be prompted prior to any adjustments being made. For example, if the consumer's usage rate exceeds the rate at which the goods are being shipped, computer system 101 can instruct computer system 102 to prompt the consumer whether the consumer would like to increase the number of units to be shipped in the future. The prompt can also display any change in the monthly subscription fee for any adjustments to the number of units to be shipped.

In some embodiments, computer system 102 can display an average usage rate along with a comparison of the consumer's current usage rate to the average usage rate. Such averages can be used to encourage consumers to use consumer goods at an appropriate or desired rate (e.g. for establishing acceptable hygiene).

In some embodiments where a scannable code is used, each unit can include a scannable code that uniquely identifies the individual unit. Such embodiments would allow for more simplified logic on computer system 102 because computer system 102 would not need to identify the consumer.

In such embodiments, before shipping the units to the consumer, computer system 101 can store (e.g. in a database) an association between the consumer and the unique identifiers of the units shipped to the consumer. Accordingly, when the code is scanned, the unique identifier alone can be sent to computer system 101. Computer system 101 then uses the unique identifier to identify the associated consumer, and can update the consumer's auto ship program as needed. The computer system 101 can require that computer system 102 prompt the consumer to upgrade or downgrade his auto ship program. In other instances, the upgrade or downgrade may be automatic if the consumer agreed to it at the outset of the subscription service.

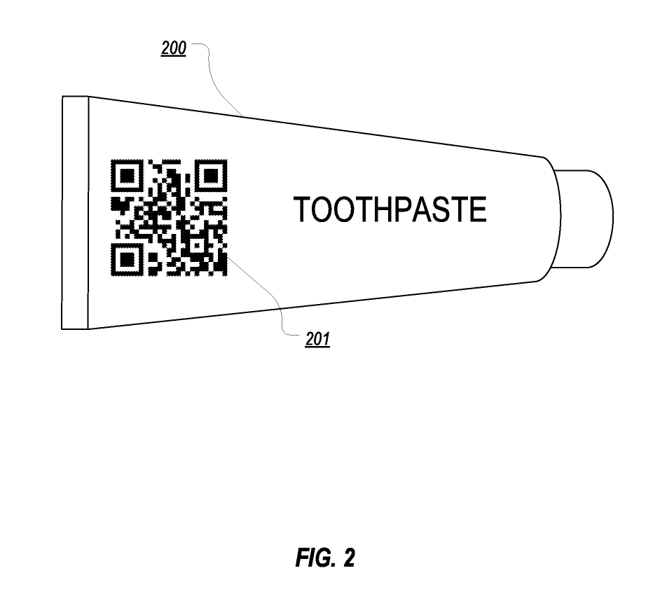

FIG. 2 illustrates a unit of toothpaste 200 that contains a QR code 201. The consumer can scan QR code 201 using computer system 102 (e.g. the consumer's mobile phone) to provide a notification to the supplier of the toothpaste 200. As described above, the consumer can scan QR code 201 at different times depending on the type or tracking implemented or desired (e.g. when receiving toothpaste 200, when opening toothpaste 200, when finishing toothpaste 200, etc.). In some embodiments, the consumer can optionally send a text to a particular number (e.g. by texting “empty” or “paste” to a 4 or 5 digit short code) that may be included on toothpaste 200 or otherwise made known to the consumer.

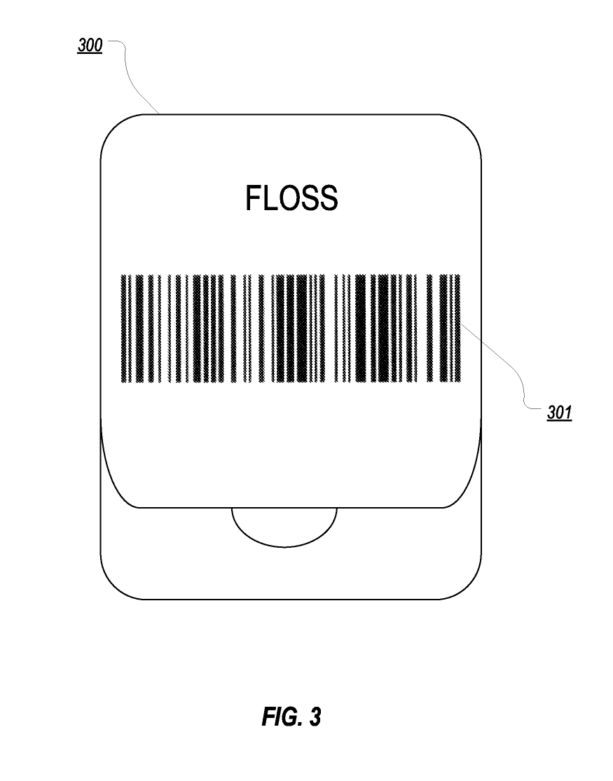

FIG. 3 illustrates a unit of floss 300 that contains a barcode 301. As with toothpaste 200, the consumer can scan barcode 301 to provide a notification to the supplier of the floss 300. Based on this notification (and possibly others) the supplier can update the auto ship program of the consumer such as by changing the quantity of floss shipped in subsequent shipments.

Mobile Application for Generating Notifications from Scanned Codes

In some embodiments, a consumer can generate and send notifications to computer system 101 using an application on a mobile phone. The application can contain functionality for scanning the code, processing the code, generating an appropriate notification from the contents of the code and information about the consumer, and sending the notification to computer system 101.

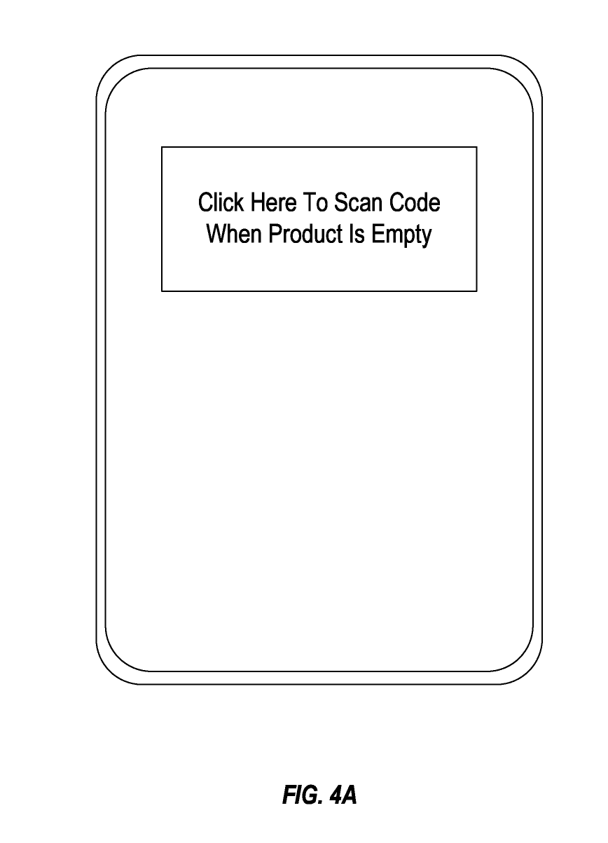

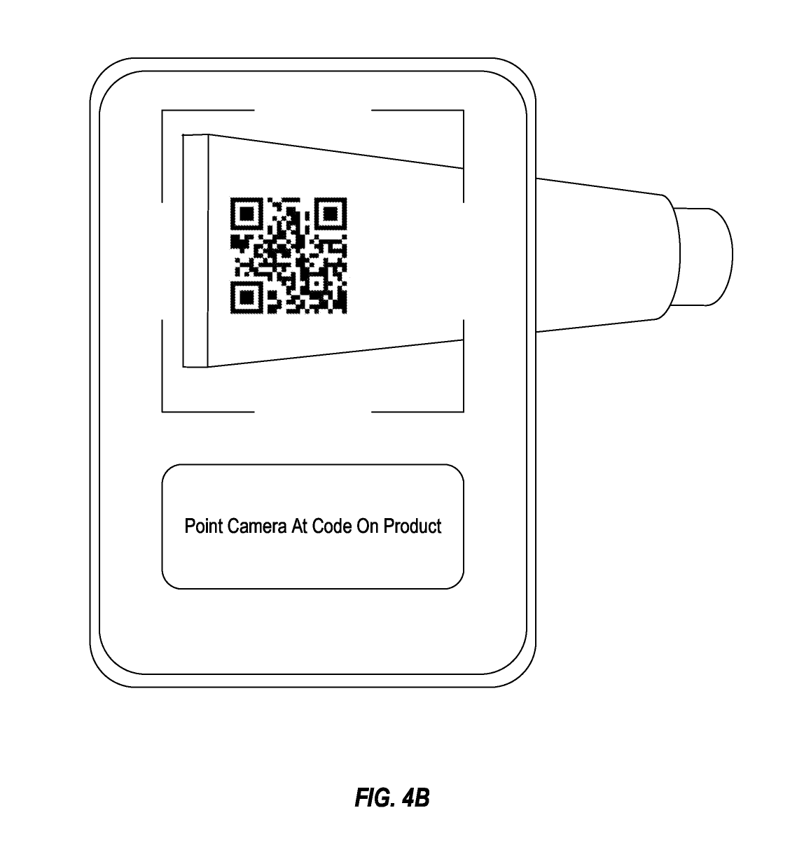

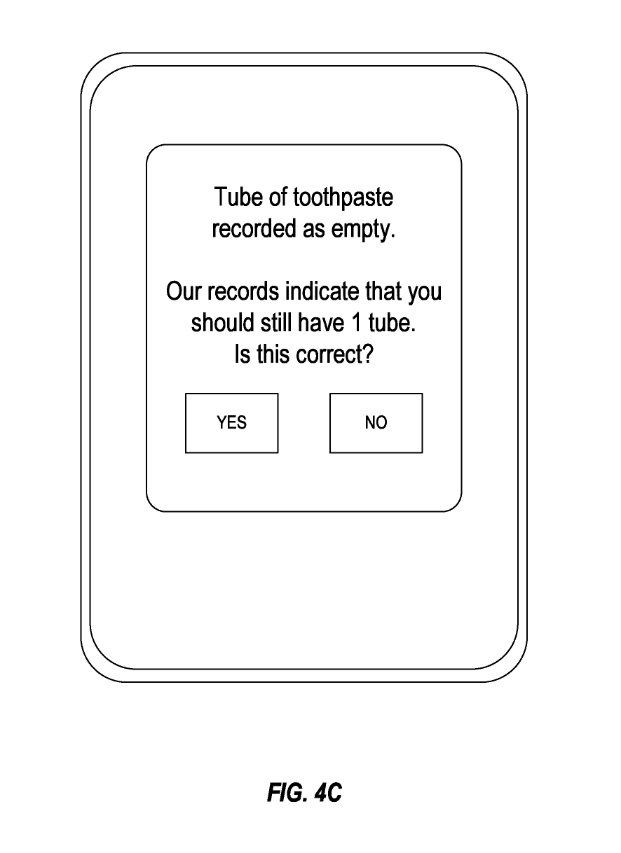

FIGS. 4A-4C illustrate example user interfaces that the mobile application can display to assist the user in generating a notification using a mobile phone. The user interfaces in FIGS. 4A-4C represent the case where a consumer scans a product only when the product is empty to generate a notification. However, similar user interfaces can be used to assist the consumer in scanning a product to generate a notification only when the product is opened, when the product is open and empty, or at some other combination of times.

FIG. 4A illustrates a user interface that displays a clickable button that the consumer can select to invoke functionality for scanning a code (e.g. by activating the phone's camera and functionality for processing a code captured by the camera).

FIG. 4B illustrates a user interface used to scan a code that can be displayed after the consumer has selected to scan a code. The user interface can include instructions for pointing the camera of the mobile phone at the code on the product and an area of the screen within which the code should be positioned. In FIG. 4B, the consumer is scanning the code on toothpaste 200.

FIG. 4C illustrates a user interface that can be displayed to the consumer to indicate that a notification has been sent to computer system 101. In FIG. 4C, the user interface displays that computer system 101 received the notification and calculated that the consumer should have one tube of toothpaste remaining The user interface allows the consumer to confirm whether the amount indicated by computer system 101 is correct. In this way, computer system 101 can correct its records if the consumer has failed to notify computer system 101 when a unit is empty.

In some embodiments, no further information is requested from the consumer. Since computer system 101 is notified when each unit of a good is empty, computer system 101 can automatically determine whether the rate at which goods are shipped needs to be adjusted.

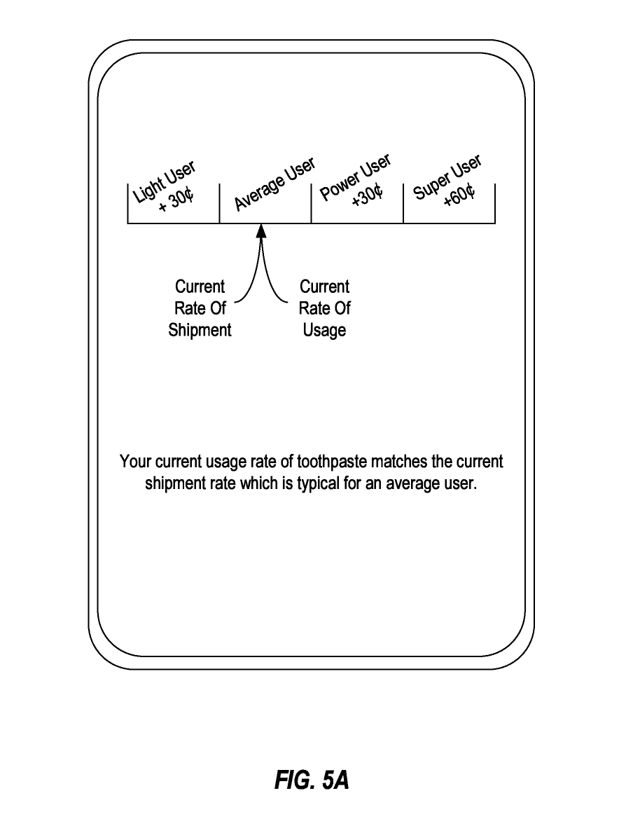

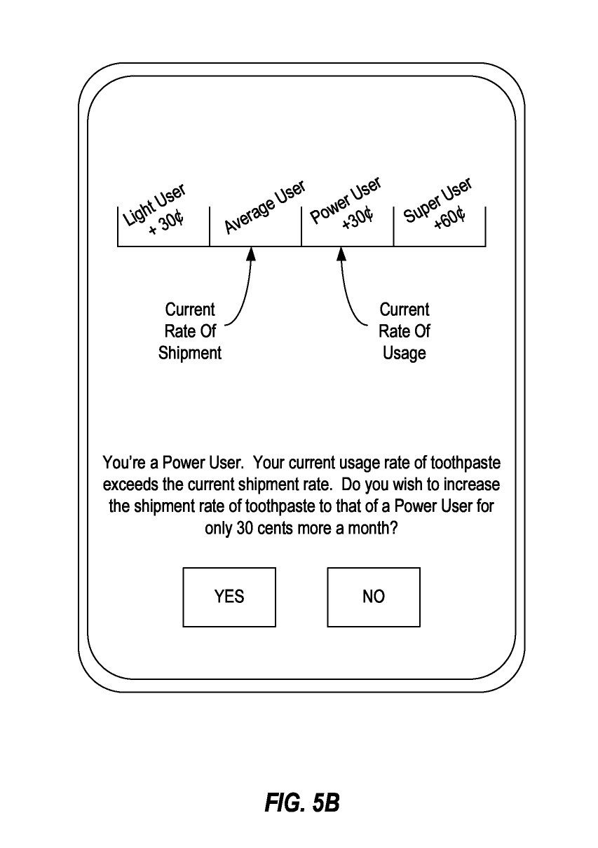

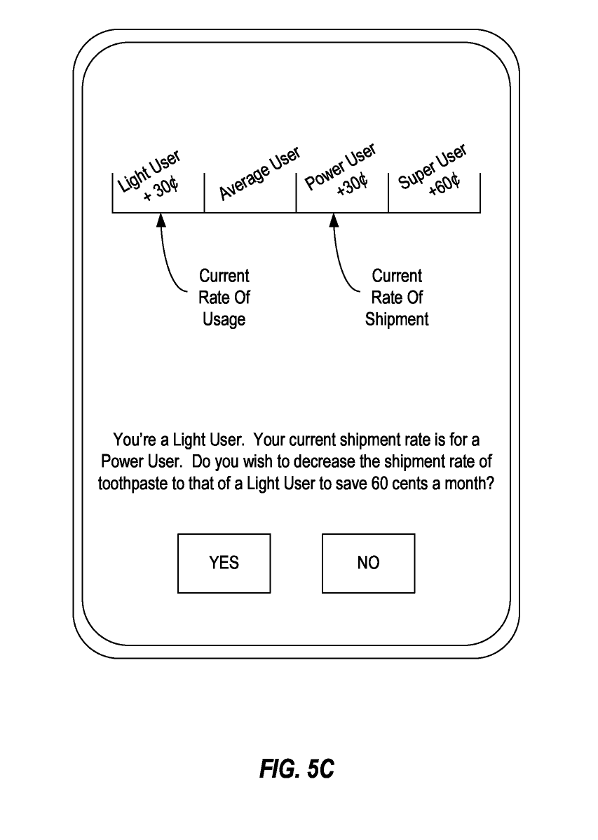

FIGS. 5A-5C illustrate various user interfaces that can be displayed to a consumer to assist the consumer in determining whether to approve an adjustment to an auto ship program. The user interfaces in FIGS. 5A-5C can be displayed to the consumer after the user interfaces in FIGS. 4A-4C are displayed, or at another time such as when the consumer requests to view his usage rate.

FIG. 5A illustrates a user interface that informs the consumer that his current rate of toothpaste usage matches the current shipment rate of toothpaste in the auto ship program.

FIG. 5B illustrates a user interface that informs the consumer that his current rate of toothpaste usage exceeds the current shipment rate of toothpaste. Accordingly, the consumer is prompted to indicate whether he would like to increase the shipment rate for 30 cents more a month to match his current usage.

FIG. 5C illustrates a user interface that informs that consumer that his current rate of toothpaste usage is below the current shipment rate. Accordingly, the consumer is prompted to indicate whether he would like to decrease the shipment rate for a savings of 60 cents per month.

In each of the examples shown in FIGS. 5A-5C, the consumer is automatically notified of his current usage rate and how it compares to his current shipment rate for the particular product. In this way, the consumer does not need to track his own usage rate. If the consumer's usage rate deviates from the shipment rate, the consumer will be automatically notified and given the opportunity to adjust the shipment rate.

Example Methods for Implementing Embodiments of the Invention

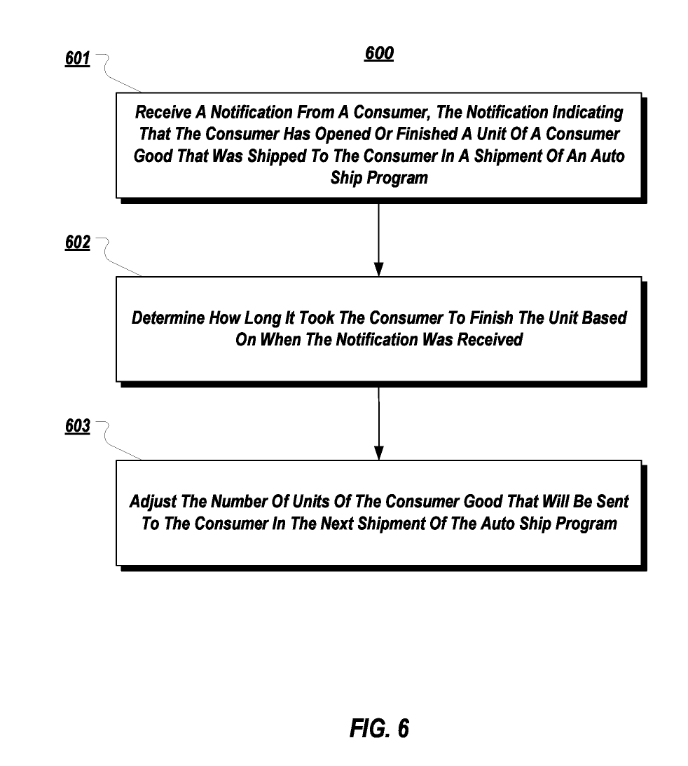

FIG. 6 illustrates a flowchart of an example method 600 that can be performed by a computer system for automatically adjusting the quantity of consumer goods shipped as part of an auto ship program. Method 600 will be described with reference to FIGS. 1 and 2.

Method 600 includes an act 601 of receiving a notification from a consumer. The notification indicates that the consumer has opened or finished a unit of a consumer good that was shipped to the consumer in a shipment of an auto ship program. For example, computer system 101 can receive a notification from computer system 102 that indicates that toothpaste 200 has been opened or finished by the consumer. This notification can be generated when computer system 102 scans a code on the unit or the packaging of the unit, when the consumer sends (e.g. via computer system 102 or another computer system) a text, email, or other communication to computer system 101, or in some other manner.

Method 600 includes an act 602 of determining how long it took the consumer to finish the unit based on when the notification was received. For example, computer system 101 can identify a time when the notification is received and compare the time to stored information about how the consumer has previously used units of toothpaste shipped to the consumer. In the case that the notification indicates that the consumer has opened toothpaste 200, a comparison can be made to a time when a previous unit of toothpaste was opened. Similarly, in the case that the notification indicates that the consumer has finished toothpaste 200, a comparison can be made to a time when toothpaste 200 was opened or when a previous unit of toothpaste was finished.

Method 600 includes an act 603 of adjusting the number of units of the consumer good that will be sent to the consumer in the next shipment of the auto ship program. For example, if it is determined that the consumer is using units of toothpaste at a rate that is slower than the rate at which the units are being shipped in the auto ship program, computer system 101 can adjust future shipments so that the rate at which units of toothpaste are shipped to the consumer matches the rate at which the consumer is using the toothpaste. This adjustment to the rate that units are shipped can be accomplished by reducing the number of units per shipment, or changing when the shipments are shipped. Also, the adjustment can be made automatically by computer system 101, or can be suggested to the consumer to request permission to make the adjustment.

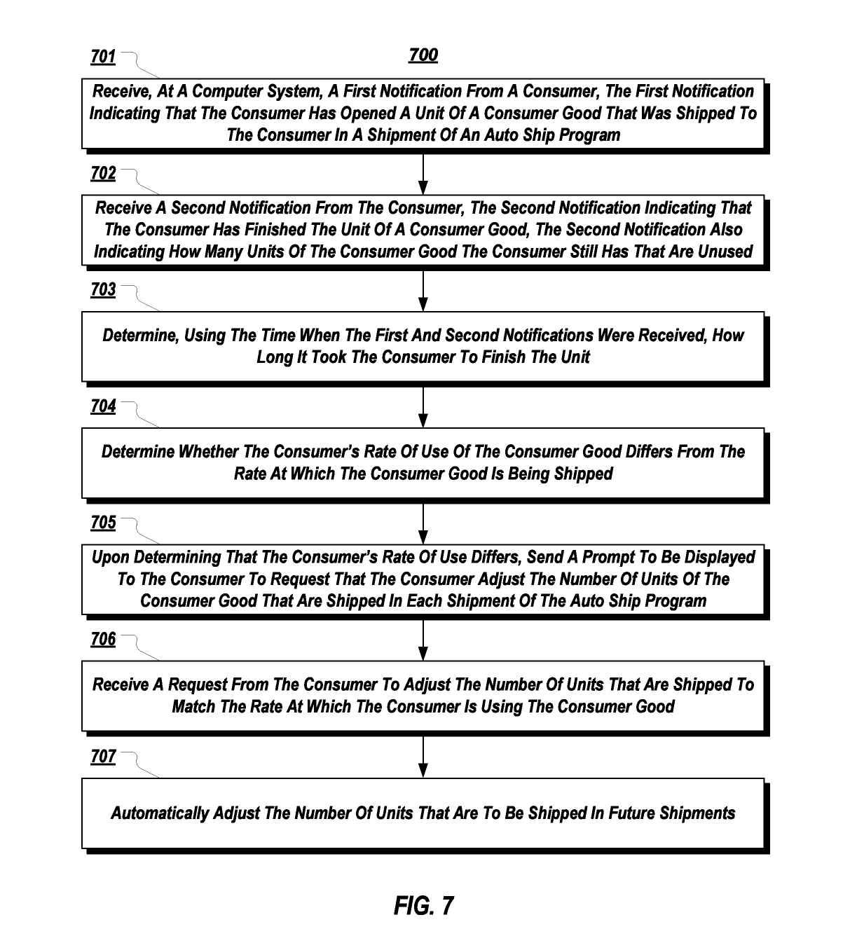

FIG. 7 illustrates a flowchart of an example method 700 for adjusting the quantity of consumer goods shipped as part of an auto ship program. Method 700 will be described with reference to FIGS. 1 and 2.

Method 700 includes an act 701 of receiving a first notification from a consumer, the first notification indicating that the consumer has opened a unit of a consumer good that was shipped to the consumer in a shipment of an auto ship program. For example, computer system 101 can receive a first notification from computer system 102 indicating that the consumer has opened toothpaste 200. The first notification can be generated in some embodiments by scanning a code printed on toothpaste 200. In some embodiments, the first notification can indicate that toothpaste 200 has been opened by the fact that it is the first notification received by computer system 101 for toothpaste 200. In other embodiments, a specific indication of toothpaste 200 being opened can be included in the first notification.

Method 700 includes an act 702 of receiving a second notification from the consumer, the second notification indicating that the consumer has finished the unit of a consumer good, the second notification also indicating how many units of the consumer good the consumer still has that are unused. For example, computer system 101 can receive a second notification from computer system 102 indicating that the consumer has finished toothpaste 200. The second notification can be generated in some embodiments by scanning a code printed on toothpaste 200. In some embodiments, the second notification can indicate that toothpaste 200 has been finished by the fact that it is the second notification received by computer system 101 for toothpaste 200. In other embodiments, a specific indication of toothpaste 200 being finished can be included in the second notification.

Method 700 includes an act 703 of determining, using the time when the first and second notifications were received, how long it took the consumer to finish the unit. For example, computer system 101 can determine the time between receiving the first and second notifications and use the time as the amount of time it took for the consumer to finish toothpaste 200.

Method 700 includes an act 704 of determining whether the consumer's rate of use of the consumer good differs from the rate at which the consumer good is being shipped. For example, computer system 101 can compare the amount of time it took the consumer to use toothpaste 200 to a rate at which units of toothpaste are being shipped as part of an auto ship program.

Method 700 includes an act 705 of, upon determining that the consumer's rate of use differs, sending a prompt to be displayed to the consumer to request that the consumer adjust the number of units of the consumer good that are shipped in each shipment of the auto ship program. For example, computer system 101 can send a prompt to computer system 102 (e.g. the consumer's mobile phone) to request that the consumer adjust the number of units of toothpaste to be shipped in subsequent shipments in the auto ship program. In some embodiments, the consumer can be prompted to reduce or increase the number of units shipped.

Method 700 includes an act 706 of receiving a request from the consumer to adjust the number of units that are shipped to match the rate at which the consumer is using the consumer good. For example, computer system 101 can receive a request from computer system 102 to increase or decrease the number of units of toothpaste that will be included in future shipments of the auto ship program.

Method 700 includes an act 707 of automatically adjusting the number of units that are to be shipped in future shipments. For example, computer system 101 can adjust the number of units of toothpaste to ship in future shipments based on the request received from computer system 102.

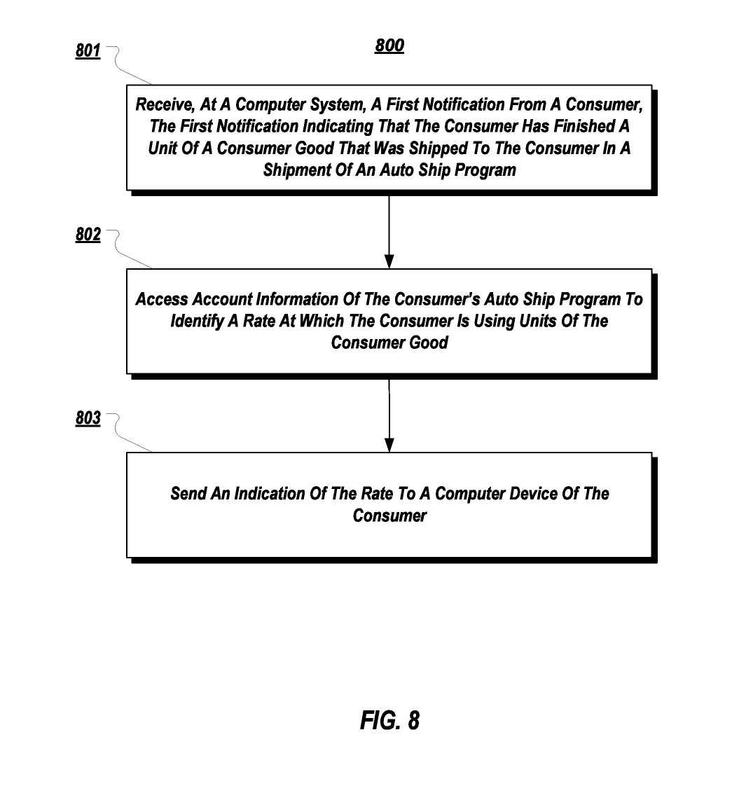

FIG. 8 illustrates a flowchart of an example method 800 for automatically determining the rate at which a consumer is using consumer goods that are shipped as part of an auto ship program. Method 800 will be described with reference to FIGS. 1 and 2.

Method 800 includes an act 801 of receiving, at a computer system, a first notification from a consumer, the first notification indicating that the consumer has finished a unit of a consumer good that was shipped to the consumer in a shipment of an auto ship program. For example, computer system 101 can receive a notification from computer system 102 when the consumer has finished toothpaste 200.

Method 800 includes an act 802 of accessing account information of the consumer's auto ship program to identify a rate at which the consumer is using units of the consumer good. For example, computer system 101 can access account information stored for the consumer. The account information can include notifications of when a previous unit of toothpaste was finished, when toothpaste 200 was opened, when one or more previous units of toothpaste were finished, or opened and finished, when a shipment that included the unit was shipped, etc.

Method 800 includes an act 803 of sending an indication of the rate to a computer device of the consumer. For example, computer system 101 can send an indication of the rate to computer system 102 so that the rate can be displayed to the consumer on computer system 102.

As can be seen, the present invention provides a simple way for the consumer to notify the provider of an auto ship program of the rate of use of auto shipped goods without actually having to know the rate of use. Because the auto ship program of the present invention automatically adjusts to the consumer's present needs, the consumer's experience with the auto ship program is greatly enhanced.

Example of Using Notifications to Adjust an Auto Ship Program

The following example illustrates how simply the consumer can generate notifications. A consumer named John signs up to receive five bottles of shampoo per month as part of an auto ship program. John is not certain how many bottles of shampoo he will use per month but believes five is a good estimate.

John receives his shipment of five bottles of shampoo on June 1 and begins using a first bottle. On June 15, John realizes that the first bottle of shampoo is empty, so he takes out his smart phone, and scans the QR code on the first bottle using an app provided as part of the auto ship program.

The app scans the QR code and automatically generates and sends a notification to a server. John does not remember when he received the shipment of shampoo, and therefore does not know that he only needs two bottles a month rather than five. However, when the server receives the notification that John has scanned the QR code on the first bottle, it accesses his account to determine that it took 15 days for John to use one bottle of shampoo (i.e. 15 days from the time of shipment), and that John still has four bottles.

Because John initially signed up for five bottles a month, the auto ship program has a shipment of five more bottles scheduled to be sent to John on July 1. The server determines that, at the current rate, John will not need any further bottles of shampoo until mid-August. Accordingly, the server cancels the shipment of shampoo for July 1, modifies the shipment of shampoo for August 1 so that only one bottle is shipped (to give John sufficient shampoo to get through August), and modifies each shipment from September on so that John receives two bottles of shampoo a month. All of these modifications are made automatically in response to John scanning the QR code.

As he continues using shampoo, John scans the QR code each time he empties a bottle. Sometimes his roommate throws away an empty bottle before John has a chance to scan the QR code with his phone, so he sends a text instead. In August, John begins using shampoo at a quicker rate. The server detects this change in John's usage, and automatically updates his shipments accordingly. John does not care how quickly he is using the shampoo because the server is modifying his shipments to make sure he always has enough.

Using Circuitry in a Seal to Transmit a Signal Indicating the Seal has Been Broken

In some embodiments of the invention, a seal on a consumer good can contain means for transmitting a signal when the seal is broken. For example, the seal may contain an RFID tag which is activated when the seal is broken. The activation can be caused by electrical, chemical, or other means. For example, the breaking of the seal may create or disrupt an electrical circuit, or cause a chemical reaction to occur that causes the RFID tag to transmit a signal to a nearby computing device (e.g. a consumer's mobile phone).

The following example demonstrates how the notification can be completely automated using the breaking of a seal. Rob has purchased mouthrinse. As Rob breaks the seal on a first bottle of mouthrinse, the energy from breaking the seal generates a signal that is readable by a nearby computing device (e.g. computer system 102). The computing device then transmits a notification to computer system 101, which then records Rob's usage. Upon breaking the seal on a second bottle of mouthrinse, the same process occurs once again and the usage rate is adjusted. Any necessary adjustments to the quantity of mouthrinse to be sent to Rob in a next shipment can be modified based on the notifications as described above.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A method for adjusting the quantity of consumer goods shipped as part of an auto ship program, the method comprising:
receiving a notification from a consumer, the notification indicating that the consumer has opened or finished a unit of a consumer good that was shipped to the consumer in a shipment of an auto ship program;
determining how long it took the consumer to finish the unit based on when the notification was received; and
adjusting the number of units of the consumer good that will be sent to the consumer in the next shipment of the auto ship program.

2. The method of claim 1, wherein the notification includes an identifier obtained from scanning a code associated with the unit.

3. The method of claim 1, wherein the notification comprises a text message.

4. The method of claim 1, wherein the notification is generated in response to receiving a signal that is generated when the consumer breaks the seal of the consumer good.

5. The method of claim 1, wherein the notification comprises the number of units of the consumer good that the consumer has remaining in stock.

6. The method of claim 1, wherein determining how long it took the consumer to finish the unit based on when the notification was received comprises:
comparing when the notification is received to when a previous notification was received.

7. The method of claim 6, wherein the notification indicates when the consumer has finished the unit, and the previous notification indicates when the consumer has finished a previous unit.

8. The method of claim 6, wherein the notification indicates when the consumer has finished the unit, and the previous notification indicates when the consumer opened the unit.

9. The method of claim 1, wherein adjusting the number of units of the consumer good that will be sent to the consumer in the next shipment of the auto ship program comprises:
automatically adjusting the number of units upon determining that the rate at which the units are being sent to the consumer does not match the rate at which the consumer is using the units.

10. The method of claim 1, wherein adjusting the number of units of the consumer good that will be sent to the consumer in the next shipment of the auto ship program further comprises:
determining that the rate at which the units are being sent to the consumer does not match the rate at which the consumer is using the units;
determining an adjustment to the rate at which the units are being sent that will cause the units to be sent at a rate that match the rate at which the consumer is using the units;
presenting the adjustment to the rate to the consumer; and
upon receiving approval of the adjustment from the consumer, adjusting the number of units of the consumer good that will be sent to the consumer in the next shipment of the auto ship program.

11. A method for adjusting the quantity of consumer goods shipped as part of an auto ship program, the method comprising:
receiving, at a computer system, a first notification from a consumer, the first notification indicating that the consumer has opened a unit of a consumer good that was shipped to the consumer in a shipment of an auto ship program;
receiving a second notification from the consumer, the second notification indicating that the consumer has finished the unit of a consumer good, the second notification also indicating how many units of the consumer good the consumer still has that are unused;
determining, using the time when the first and second notifications were received, how long it took the consumer to finish the unit;
determining whether the consumer's rate of use of the consumer good differs from the rate at which the consumer good is being shipped;
upon determining that the consumer's rate of use differs, sending a prompt to be displayed to the consumer to request that the consumer adjust the number of units of the consumer good that are shipped in each shipment of the auto ship program;
receiving a request from the consumer to adjust the number of units that are shipped to match the rate at which the consumer is using the consumer good; and
automatically adjusting the number of units that are to be shipped in future shipments.

12. The method of claim 11, wherein the first notification indicates that a code on the unit of the consumer good has been scanned.

13. The method of claim 11, wherein the second notification is received in response to sending a request to a computer system used by the consumer, the request prompting the consumer to confirm a number of units of the consumer good that the consumer still has.

14. A method for automatically determining the rate at which a consumer is using consumer goods that are shipped as part of an auto ship program, the method comprising:
receiving, at a computer system, a first notification from a consumer, the first notification indicating that the consumer has finished a unit of a consumer good that was shipped to the consumer in a shipment of an auto ship program;
accessing account information of the consumer's auto ship program to identify a rate at which the consumer is using units of the consumer good; and
sending an indication of the rate to a computer device of the consumer.

15. The method of claim 14, wherein accessing account information of the consumer's auto ship program to identify a rate at which the consumer is using units of the consumer good comprises:
identifying when a second notification was receive that indicated when the consumer finished a previous unit of the consumer good;
determining the duration of time between when the second notification and first notification were received; and
calculating the rate based at least partially on the determined duration.

16. The method of claim 14, wherein accessing account information of the consumer's auto ship program to identify a rate at which the consumer is using units of the consumer good comprises:
identifying when a second notification was receive that indicated when the consumer opened the unit of the consumer good;
determining the duration of time between when the second notification and first notification were received; and
calculating the rate based at least partially on the determined duration.

17. The method of claim 14, wherein the indication of the rate includes an indication of the rate at which units of the consumer good are being shipped in the auto ship program.

18. The method of claim 17, wherein, when the rate at which the units of the consumer good are shipped differs from the rate at which the consumer is using the units of the consumer good, the method further comprises:
sending a request to the computer device of the consumer that prompts the consumer to indicate whether the rate at which the units of the consumer good are shipped should be adjusted to match the rate at which the consumer is using the units.

19. The method of claim 18, further comprising:
receiving an indication from the consumer that the rate at which the units of the consumer good are shipped should be adjusted to match the rate at which the consumer is using the units; and
automatically adjusting the number of units of the consumer good that will be shipped in the next shipment of the auto ship program so that the units of the consumer good are shipped at a rate that matches the rate at which the consumer is using the consumer goods.

20. The method of claim 14, wherein the account information identifies how long it took for the consumer to use each of a plurality of units of the consumer good.
